(19) United States
(12) Patent Application Publication
(10) Pub. No.: US 2017/0270518 A1
(43) Pub. Date: Sep. 21, 2017

(54) METHODS AND SYSTEMS FOR FACILITATING ANONYMOUS PURCHASES

(71) Applicant: PCMS Holdings, Inc., Wilmington, DE (US)

(72) Inventor: Markku KYLÄNPÄÄ, Helsinki (FI)

(21) Appl. No.: 15/505,543

(22) PCT Filed: Aug. 13, 2015
(86) PCT No.: PCT/US2015/045118

§ 371 Date: Feb. 21, 2017

Related U.S. Application Data
(60) Provisional application No. 62/040,814, filed on Aug. 22, 2014.

(51) Int. Cl. G06Q 20/38; G06Q 30/06

(52) U.S. Cl. CPC G06Q 20/383; G06Q 30/0635; G06Q 30/0637

(57) ABSTRACT

In an embodiment, a merchant server receives, from a client device, an order message identifying an ordered product having a purchase price. The merchant server generates an order identifier associated with the ordered product and sends, to the client device an order-response message that includes the generated order identifier. The merchant server receives, from the client device, an order-arranged message that includes a payment-arranged message (having a payment amount, the order identifier, and a digital signature of a financial institution) and a delivery-arranged message (having delivery-plan data and a digital signature of a courier). The merchant server verifies the respective digital signatures of the financial institution and the courier, and generates and outputs transfer instructions for the ordered product based at least in part on the delivery-plan data.

### CROSS REFERENCE TO RELATED APPLICATIONS

The present application is a non-provisional filing of, and claims benefit under 35 U.S.C. §119(e) from, U.S. Provisional Patent Application Ser. No. 62/040,814, filed Aug. 22, 2014, the contents of which are incorporated herein by reference in their entirety.

### BACKGROUND

Numerous merchants now provide Internet-connected online storefronts that allow prospective purchasers to review and buy a wide variety of products. Purchasers can electronically pay for their purchases and can arrange for purchased products to be delivered to a destination of their choice.

### BRIEF DESCRIPTION OF THE DRAWINGS

A more detailed understanding may be had from the following description, presented by way of example in conjunction with the accompanying drawings, wherein:

FIG. 1 illustrates an example operation of an embodiment of the disclosure.

FIG. 2 depicts a communication network, in accordance with at least one embodiment.

FIG. 3 depicts a computing device, in accordance with at least one embodiment.

FIG. 4 depicts example abstraction layers implemented by a computing device, in accordance with at least one embodiment.

FIG. 5 depicts example network layers at which respective computing devices may communicate, in accordance with at least one embodiment.

FIG. 6 depicts a message flow between computing devices in a communication network, in accordance with at least one embodiment.

FIG. 7 depicts a flowchart of a method carried out by a merchant-associated computing device, in accordance with at least one embodiment.

FIG. 8 depicts a flowchart of a method carried out by a client-associated computing device, in accordance with at least one embodiment.

FIG. 9 depicts an example wireless transmit/receive unit (WTRU).

### DETAILED DESCRIPTION

While online storefronts typically allow prospective purchasers to browse anonymously, purchase generally requires the purchaser to register with the storefront, which in turn usually requires the purchaser to provide personally-identifying information to the storefront. This personally-identifying information might be used by the storefront for tracking the purchaser's shopping habits and for sending unwanted marketing material to the purchaser.

Described herein are methods and systems for facilitating anonymous purchases. At least one embodiment takes the form of a method carried out by a merchant server. The merchant server receives, from a client device, an order message identifying an ordered product (the ordered product having a purchase price). The merchant server generates an order identifier associated with the ordered product and sends, to the client device, an order-response message that includes the generated order identifier. The merchant server receives, from the client device, an order-arranged message that includes a payment-arranged message and a delivery-arranged message. The payment-arranged message includes a payment amount, the order identifier, and a digital signature of a financial institution, and the delivery-arranged message includes delivery-plan data and a digital signature of a courier. The merchant server verifies the respective digital signatures of the financial institution and the courier and, in response to the verification, generates transfer instructions for the ordered product based at least in part on the delivery-plan data and outputs the generated transfer instructions. At least one embodiment takes the form of a merchant server configured to perform the above-described method.

In at least one embodiment, in response to the verification, the merchant releases the ordered product to the courier. In some embodiments, the merchant releases the ordered product to the courier in response to the transfer instructions.

In at least one embodiment, the merchant server receives, from the financial institution (such as a bank) and in association with the order identifier, a payment in the amount of the payment amount. In at least one such embodiment, the merchant server generates the transfer instructions subsequent to both the verification and receiving the payment.

In at least one embodiment, prior to sending the order-response message to the client device, the merchant server inserts, into the order-response message, a digital signature associated with the merchant server.

In at least one embodiment, the digital signature of the financial institution is based on a private key that is inaccessible to the merchant server, and verifying the digital signature of the financial institution includes verifying the digital signature of the financial institution based on a public key that is associated with the private key and that is accessible to the merchant server. In at least one such embodiment, the merchant server accesses the public key from a digital certificate that further includes identity information of the financial institution and a digital signature of a trusted certificate authority.

In at least one embodiment, prior to outputting the generated transfer instructions, the merchant server (i) verifies that the order identifier received in the payment-arranged message matches the generated order identifier, and (ii) verifies that the payment amount matches the purchase price.

In at least one embodiment, prior to outputting the generated transfer instructions, the merchant server sends, to a financial-institution server associated with the financial institution, a payment-verification-request message that includes the order identifier and the purchase price. The merchant server receives, from the financial-institution server, a payment-verification-acknowledgement message that includes the order identifier, a payment-verification indicator, a verified-payment amount, and a second digital signature of the financial institution. The merchant server verifies the second digital signature of the financial institution, confirms that the payment-verification indicator is true, and confirms that the verified-payment amount is equal to the purchase price.

In at least one embodiment, the digital signature of the courier is based on a private key that is inaccessible to the merchant server, and verifying the digital signature of the courier includes verifying the digital signature of the courier based on a public key that is associated with the private key and that is accessible to the merchant server. In at least one such embodiment, the merchant server accesses the public key from a digital certificate that further includes identity information of the courier and a digital signature of a trusted certificate authority.

In at least one embodiment, the delivery-plan data includes the order identifier, and the merchant server verifies that the order identifier received in the delivery-plan data matches the generated order identifier.

In at least one embodiment, prior to outputting the generated transfer instructions, the merchant server sends, to a courier server associated with the courier, a delivery-verification-request message that includes the order identifier. The merchant server receives, from the courier server, a delivery-verification-acknowledgement message that includes the order identifier, a delivery-verification indicator, and a second digital signature of the courier. The merchant server verifies the second digital signature of the courier and confirms that the delivery-verification indicator is true.

In at least one embodiment, the merchant server generates an order-confirmation message that includes the received payment-arranged message and the received delivery-arranged message. The merchant server inserts, into the order-confirmation message, a digital signature associated with the merchant server, and sends the order-confirmation message to the client device.

In at least one embodiment, the order-response message comprises client instructions that, if executed by the client device, cause the client device to (i) send, to a financial-institution server associated with the financial institution, a payment-arrangement-request message that includes the order identifier and the purchase price, and (ii) receive the payment-arranged message from the financial-institution server. The client instructions further cause the client device to (i) send, to a courier server associated with the courier, a delivery-arrangement-request message that includes the order identifier, and (ii) receive the delivery-arranged message from the courier server. The client instructions further cause the client device to (i) generate the order-arranged message to include the payment-arranged message and the delivery-arranged message, and (ii) send the generated order-arranged message to the merchant server.

In at least one embodiment, the client instructions further cause the client device to, prior to sending the order-arranged message to the merchant server, verify the respective digital signatures of the financial institution the courier.

In at least one embodiment, the client instructions to send the payment-arrangement-request message include instructions to include a digital signature of the client device in the payment-arrangement-request message.

In at least one embodiment, the client instructions to send the delivery-arrangement-request message include instructions to include a digital signature of the client device in the delivery-arrangement-request message.

At least one embodiment takes the form of a method carried out by a client device. In at least one embodiment, the client device (i) sends, to a merchant server, an order message identifying an ordered product, and (ii) receives, from the merchant server, an order-response message that includes an order identifier. The ordered product has a purchase price and the order identifier is associated with the ordered product. The client device (i) sends, to a financial-institution server associated with a financial institution, a payment-arrangement-request message that includes the order identifier and the purchase price, and (ii) receives, from the financial-institution server, a payment-arranged message that includes a payment amount, the order identifier, and a digital signature of the financial institution. The client device (i) sends, to a courier server associated with a courier, a delivery-arrangement-request message that includes the order identifier, and (ii) receives, from the courier server, a delivery-arranged message that includes delivery-plan data and a digital signature of a courier. The client device (i) generates an order-arranged message that includes the payment-arranged message and the delivery-arranged message, and (ii) sends the generated order-arranged message to the merchant server. At least one embodiment takes the form of a client device configured to perform the above-described method.

In at least one embodiment, prior to sending the generated order-arranged message to the merchant server, the client device verifies the respective digital signatures of the financial institution and the courier.

In at least one embodiment, prior to sending the payment-arrangement-request message to the financial-institution server, the client device inserts, into the payment-arrangement-request message, a digital signature associated with the client device. In at least one such embodiment, a public key that is associated the digital signature of the client device is accessible to the financial-institution server and inaccessible to the merchant server.

In at least one embodiment, prior to sending the delivery-arrangement-request message to the courier server, the client device inserts, into the delivery-arrangement-request message, a digital signature associated with the client device.

A detailed description of illustrative embodiments will now be provided with reference to the various figures. Although this description provides detailed examples of possible implementations, it should be noted that the provided details are intended to be by way of example and in no way limit the scope of the application.

### Example Operation

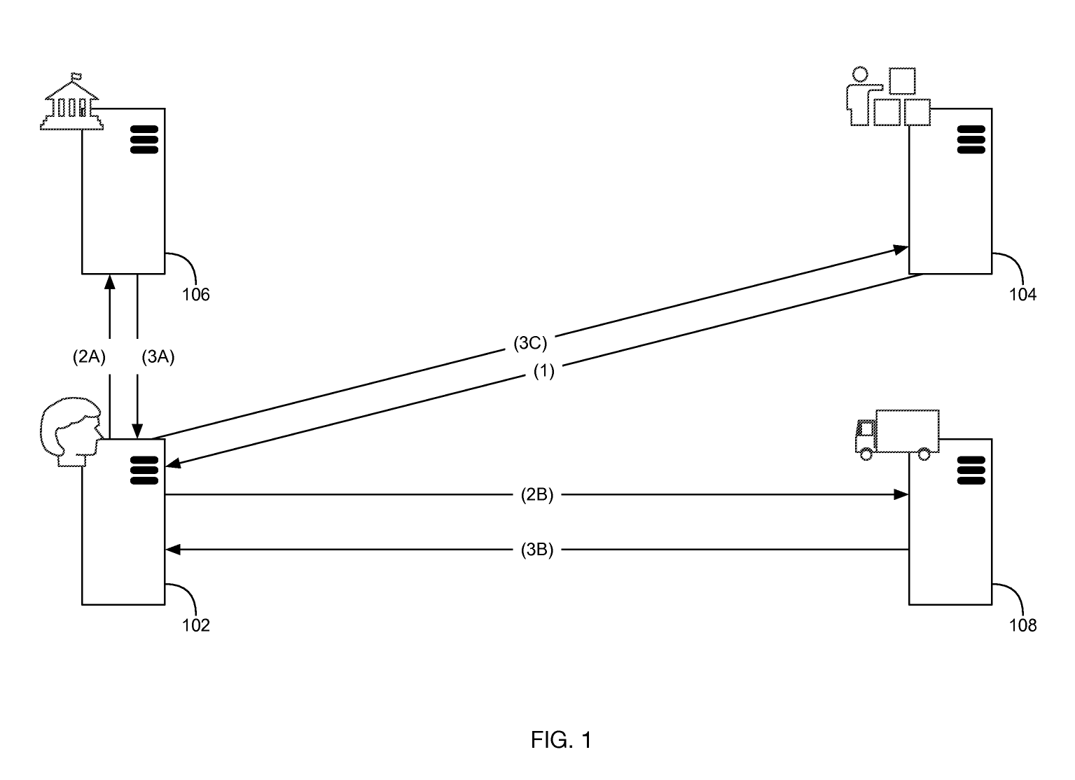

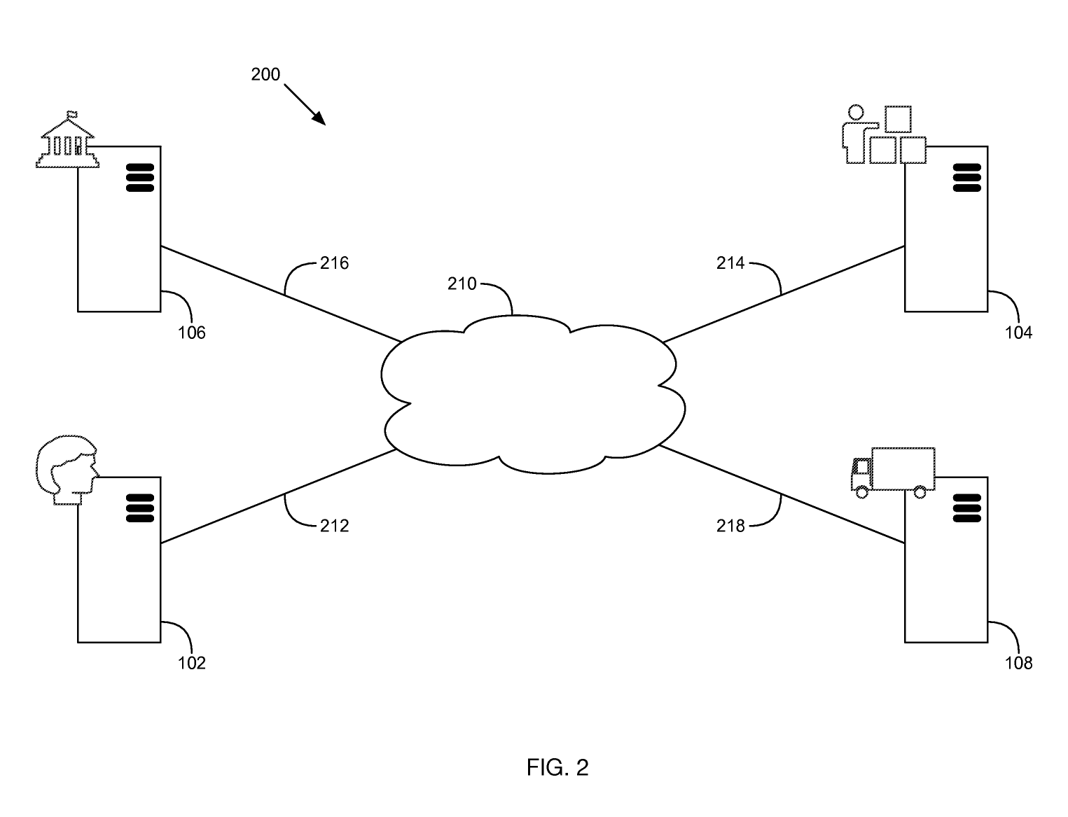

FIG. 1 illustrates an example operation of an embodiment of the disclosure. As shown, several messages are exchanged between computing devices 102, 104, 106, and 108, which take the form of or at least include a client device, a merchant server, a financial-institution server, and a courier server, respectively. Any one or more of the computing devices could take the form of or at least include desktop computers, notebook computers, and/or server computers (among other possibilities including but not limited to tablet computers and other mobile devices), the combination of which (in addition to one or more communication links) may form or at least be connected to one or more communication networks. Additional examples and arrangements of these (and possibly other) computing devices and arrangements are provided throughout this disclosure, including several examples described below with reference to FIGS. 2 through 5 and FIG. 9.

In an embodiment, each of the computing devices is associated with a respective party that is involved in an online purchase. In an example, client device 102 is associated with a client, merchant server 104 is associated with a merchant, financial-institution server 106 is associated with a financial institution, and courier server 108 is associated with a server. The merchant provides an online storefront that allows for anonymous purchasing using one or more given payment methods (such as credit-card payments, bank transfers, and/or online money transfers (such as PayPal®), etc.) and one or more shipping methods (such as normal or expedited delivery via FedEx® or DHL®, etc.). The client may have an established relationship with the financial institution and/or the courier. For example, the client may have credit card, a checking account, and/or a savings account with the financial institution. As another example, the client may have an account with the courier, according to which shipping costs may be based on a flat fee and/or based on the shipping destination, the weight and/or dimensions of the shipped item, and/or the shipping method for the shipped item.

In the illustrated embodiment, merchant server 104 provides, to client device 102, a message (1) that includes an identifier and a purchase price of an order initiated by the client. The client could have initiated the order by providing the merchant with an identification of one or more ordered products offered for sale by the merchant. The client need not provide any personally-identifying information to the merchant to initiate the order, and message (1) does not need to contain (and in exemplary embodiments does not contain) an identification of the ordered products or any personally-identifying information with respect to the client.

Upon receiving message (1), client device 102 sends messages (2A) and (2B) to financial-institution server 106 and courier server 108, respectively. The message (2A) to financial-institution server 106 includes the received order identifier, the purchase price, and any personally-identifying information required by the financial institution to facilitate payment to the merchant. The personally-identifying information in the message (2A) to financial-institution server 106 could include a credit card number and an address of the client, or perhaps a username and password (for retrieving any credit card numbers that the client may have previously provided to the financial institution). The message (2B) to courier server 108 includes the order identifier and any personally-identifying information (such as a delivery address) required by the courier to facilitate delivery of the ordered products to the client.

Client device 102 then receives messages (3A) and (3B) from financial-institution server 106 and courier server 108, respectively. In this example, the message (3A) from financial-institution server 106 includes the order identifier, a payment amount, and a digital signature of the financial institution. The message (3A) represents a commitment by the financial institution to pay the merchant the indicated amount for the identified order. The message (3B) from the courier server 108 includes the order identifier and a digital signature of the courier. The message (3B) represents the courier's commitment to facilitate shipment of the ordered packages from the merchant to the client. The messages are not required to contain (and in exemplary embodiments do not contain) any credit card numbers, delivery addresses, or any other personally-identifying information with respect to the client.

Upon receiving the messages (3A) and (3B), the client device 102 forwards the messages (3A) and (3B) to merchant server 104, as shown at (3C) in FIG. 1. Based on the digital signatures included in the messages, the merchant can verify that the messages (3A) and (3B) originated from the financial institution and courier, respectively, and can ensure that the messages were not altered by client device 102. The merchant could then provide the courier with one or more packages associated with the order, without revealing the contents of those packages, for shipment to the client, and await payment for the order from the financial institution.

In this example, the merchant has information regarding which products are associated with the order (and how much those products cost), but does not know exactly where the client is located or what the client may have previously purchased from the merchant. The financial institution knows the identity of the client and the total purchase price of the order, but does not know the specific products or shipping information associated with the order. The courier knows the identity of the client and the delivery location for the order, but doesn't know the contents of the package(s) or the purchase price of the order.

It should be understood that, in the context of this disclosure, an “anonymous” purchase is not necessarily a purchase for which no personally-identifying information of the client is provided to the merchant, the financial institution, the courier, and/or any other parties involved in the purchase. Some potentially personally-identifying information such as Internet Protocol (IP) addresses and/or non-specific geographic locations (such as a purchaser's domiciled country, state, or city) may be sent to (or otherwise acquired) by any one or more of the parties. In some embodiments, additional anonymizing techniques such as the use of onion routers may be employed.

Servers 104-108 could take the form of one or more application servers, web servers, database servers, file servers, key-management servers, and/or any other types of servers, among other possibilities. For example, merchant server 104 could take the form of (or include) a web shop that provides visitors with shopping-cart functionality and that monitors and/or maintains an inventory of one or more products that customers may purchase via the web shop. A respective server may function (partially or completely) autonomously by, e.g., automatically processing any received messages and automatically sending one or more response messages. For example, any one or more of servers 104-108 may automatically verify any digital signatures included in received messages.

Client device 102 may perform one or more client-device functions via a web browser, an application that contains web-browser functionality, a web-browser plugin, and/or any combination of these, as examples. For example, a web browser may be used to browse a web store of a merchant. Via the browser, one or more products may be added to a shopping cart shipment and payment information may be provided to the merchant. Client device 102 may function partially or completely autonomously by, e.g., automatically (and anonymously) purchasing a product if certain conditions are satisfied.

### Example Communication Network

FIG. 2 depicts a communication network, in accordance with at least one embodiment. As shown, communication network 200 includes computing devices 102-108, each of which are interconnected via respective communication links 212, 214, 216, and 218. Network 200 could take the form of or at least include a Wide Area Network (WAN), a Local Area Network (LAN), and/or a Personal Area Network (PAN), and could further include one or more additional networks (such as network 210). Different and/or additional entities could also be present: for example, communication network 200 could include one or more additional computing devices and/or communication links.

Computing devices 102-108 may be any devices capable of carrying out the computing-device functions described herein. In addition to the forms described above, any one or more of the computing devices could take the form of or at least include one or more general-purpose computers, personal computers, laptop computers, tablets, smartphones, and/or personal digital assistants (PDAs), among other possibilities. One or more of the computing devices may include a user interface, which could take the form of or at least include hardware and/or software for performing various user-interface functions. Additionally or alternatively, any of the computing devices could take the form of or at least include one or more hardware servers that, individually or collectively, function as database servers, file servers, mail servers, web servers, and/or application servers, among many other possibilities. Computing devices 102-108 may take other forms.

Network 200 and/or 210 could take the form of or at least include one or more well-known networks such as the Internet. In an embodiment, network 200 and/or 210 takes the form of the Tor network, which passes network traffic through various intermediate nodes so as to obfuscate the source of that traffic. Those of skill in the art will appreciate that network 200 and/or 210 may take other forms.

Any one or more of communication links 212-218 could take the form of or at least include respective physical and/or logical links, and could include one or more communication devices, networks, connections, switches, bridges, routers, and the like. Any or all of communication links 212-218 could make use of wired and/or wireless forms of communication. Moreover, one or more communication links instead of and/or in addition to communication links 212-218 could be present. As one example, there could be one or more communication links between computing device 102 and network 210.

### Example Computing Device

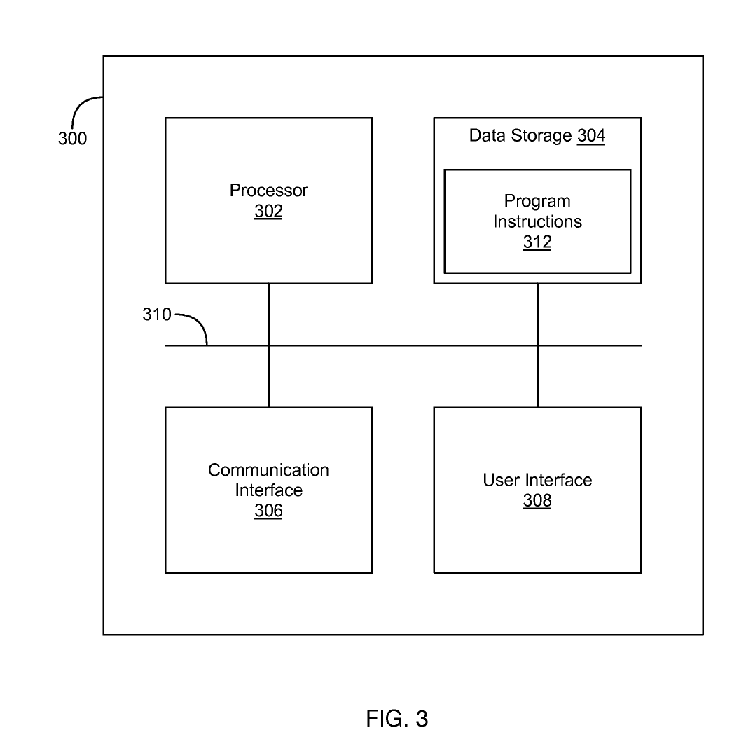

FIG. 3 depicts a computing device, in accordance with at least one embodiment. As shown, computing device 300 includes a processor 302, a data storage 304, a communication interface 306, and a user interface 308, each of which are interconnected via a bus, network, or other communication link 310. It should be understood that the computing device could include different and/or additional elements. For example, in some instances, a user interface may not be present.

Processor 302 may include one or more processors of any type deemed suitable by those of skill in the relevant art, some examples including a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and/or any combination of these, among other possibilities. Processor 302 may provide signal coding, data processing, power control, input/output processing, and/or any other functionality, as examples.

Data storage 304 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. In the embodiment depicted in FIG. 3, data storage 304 contains program instructions 312 executable by processor 302 for carrying out various combinations of the various functions described herein. The data storage could include additional data as well, including (for example) product listings, product reviews, user profiles, network routing data, and/or any other types of data deemed suitable by those of skill in the relevant art for carrying out the functions described herein.

Communication interface 306 could include one or more wired-communication interfaces and/or one or more wireless-communication interfaces. The communication interface may operate according to one or more communication protocols such as IEEE 802.3 (Ethernet), Synchronous Optical Networking (SONET), IEEE 802.11 (Wi-Fi), Bluetooth, ZigBee, Long-Term Evolution (LTE), Global System for Mobile Communications (GSM), CDMA2000, TErrestrial Trunked RAdio (TETRA), and/or any another communication protocol or standard, among many other possibilities known to those of skill in the relevant art.

User interface 308 may be any component capable of carrying out the user-interface functions described herein. The user interface may be configured to both receive input from a user and output information to the user. User input may be received via a keyboard, a mouse, a touchpad, a keypad, a microphone, a touchscreen display, and/or one or more other user-input components and/or devices. Output may be provided via a computer monitor (e.g., a liquid crystal display (LCD) and/or an organic light-emitting diode (OLED) display), one or more audio speakers, and/or one or more other user-output components and/or devices. Some components, such as a touchscreen display for example, may provide for both input and output. Those having skill in the art will understand that user interface 308 may take numerous other forms as well.

### Example Computing-Device Abstraction Layers

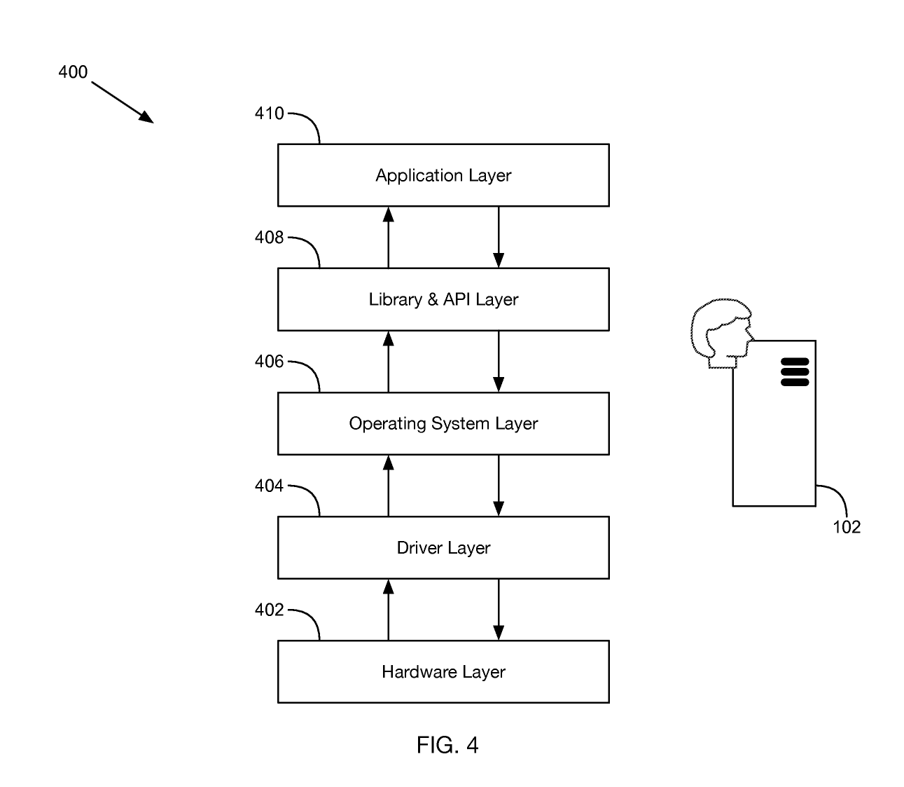

FIG. 4 depicts example abstraction layers implemented by a computing device, in accordance with at least one embodiment. As shown, abstraction layers 400 of computing device 300 include a hardware layer 402, a driver layer 404, an operating system layer 406, a library and application programming interface (API) layer 408, and an application layer 410.

Generally, each of layers 402-408 relies on the functionality of the layer below and provides functionality to the layer above. For example, hardware layer 402 may include one or more processors, data storages, caches, timers, buses, and/or interrupt controllers (as examples) and driver layer 404 may include one or more device drivers that control one or more respective devices or components in hardware layer 402. Operating system layer 406 may include one or more operating-system kernels that interface with device drivers in driver layer 404 to provide interrupt handling, process scheduling, memory management, and/or file system access, among other functions. Library & API layer 408 may include one or more APIs that expose one or more system function calls provided by the operating system in operating system layer 506. Layer 408 may also include one or more libraries (e.g., dynamically-linked libraries or “DLLs”) that allow access to these system function calls.

Application layer 410 may include one or more applications such as one or more web browsers, email clients, word processors, server daemons, etc. Such applications may implement one or more APIs from library & API layer 408 and may function by interacting with one or more libraries from layer 408. Application layer 410 may itself include one or more layers—for example, a web browser within a web-browser layer of application layer 410 may render or execute code (such as HyperText Markup Language (HTML) and/or JavaScript) in a web-content layer of application layer 410. Additionally or alternatively, the web browser may expose, via an API, one or more browser functions to browser plugins within a plugin layer of application layer 410. As another example, an application server within an application-server layer of application layer 410 may expose one or more functions to web applications within a web-application layer of application layer 410.

Applications within layer 410 (as well as individual processes of an application) may communicate by exchanging data via operating-system function calls exposed by one or more APIs within API/Library layer 408. Such communication could take the form of named pipes, domain sockets, shared memory, SOAP, XML-RPC, inter-process communication (IPC), and/or other types of communication, as just some examples. A given application in application layer 410 could span multiple computing devices—e.g., as in the case of distributed computing, grid computing, cluster computing, and these applications may coordinate their execution according to one or more these types of communication. As an example, a given web application may be provided by multiple application servers executing on respective computing devices, and the application servers may coordinate execution of the web application via IPC.

It will be understood that the functions of client device 102, merchant server 104, financial-institution server 106, and/or courier server 108 may be implemented within any one or more of these (or other) layers. Further, those of skill in the art will appreciate that a given computing device may implement different and/or additional abstraction layers, and that respective computing devices (such as computing device 102-108) may implement any combination of these or other abstraction layers.

### Example Network-Communication Layers

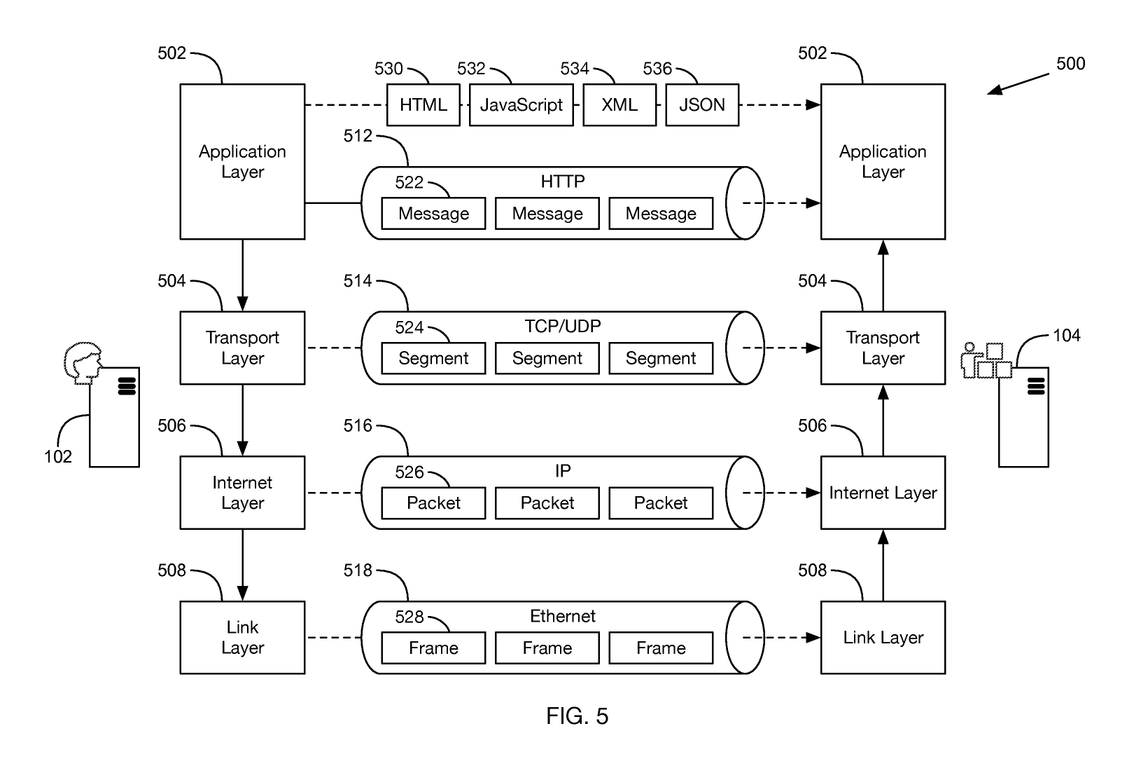

FIG. 5 depicts example network layers at which respective computing devices may communicate, in accordance with at least one embodiment. As shown in FIG. 5, computing devices 102 and 104 communicate via an application layer 502, a transport layer 504, an Internet layer 506, and a link layer 508. Similar to the device layers depicted in FIG. 4, layers 502-508 will typically rely on communication services provided by the layer below, and will in turn provide communication services for the layer above. Those of skill in the art will appreciate that computing devices 102 and 104 may communicate at other layers not illustrated in FIG. 5 and that computing devices 106 and 108 may communicate at similar network layers.

In the illustrated embodiment, application layer 502 facilitates communication between client device 102 and merchant server 104 using one or more messages 522 according to the Hypertext Transfer Protocol (HTTP) 512. Messages 522 may be used to send application-layer data such as Hypertext Markup Language (HTML) 530, JavaScript 542, Extensible Markup Language (XML) 534, JavaScript Object Notation (JSON) 536, Secure/Multipurpose Internet Mail Extensions (S/MIME), and/or other types of data, among other possibilities. For example, a web browser of client device 102 may communicate with an application server of merchant server 104 using HTML data and JavaScript data exchanged using HTTP. Those of skill in the art will appreciate that other application-layer protocols such as Secure Sockets Layer (SSL), Transport Layer Security (TLS), and/or Secure Shell (SSH) may be used in addition to (or instead of) HTTP, and that other types of application-layer data (perhaps representing additional network layers above application layer 502) may be exchanged via these application-layer protocols.

Transport layer 504 provides for communication between client device 102 and merchant server 104 using one or more segments 524 (representing a given message 52) according to the Transmission Control Protocol (TCP) and/or the User Datagram Protocol (UDP) (represented collectively as TCP/UDP 514), and Internet layer 506 facilitates the routing of packets 524 of one or more segments 524 between computing devices 102 and 104 according to the Internet protocol 514. Link layer 508 facilitates communication between client device 102 and merchant server 104 by exchanging one or more frames 528, possibly via one or more intermediate computing devices, according to the Ethernet protocol 518. Additionally or alternatively, other link-layer protocols may be used—protocols such as Synchronous Optical Networking (SONET), Synchronous Digital Hierarchy (SDH), Asynchronous Transfer Mode (ATM), Frame Relay, T1/E1, ATM, DSL, and/or 802.11, among other possibilities. Frames 528 may be exchanged over one or more physical links such as copper, twisted pair, coax, fiber, and radio links, as examples.

### Example Message Flow

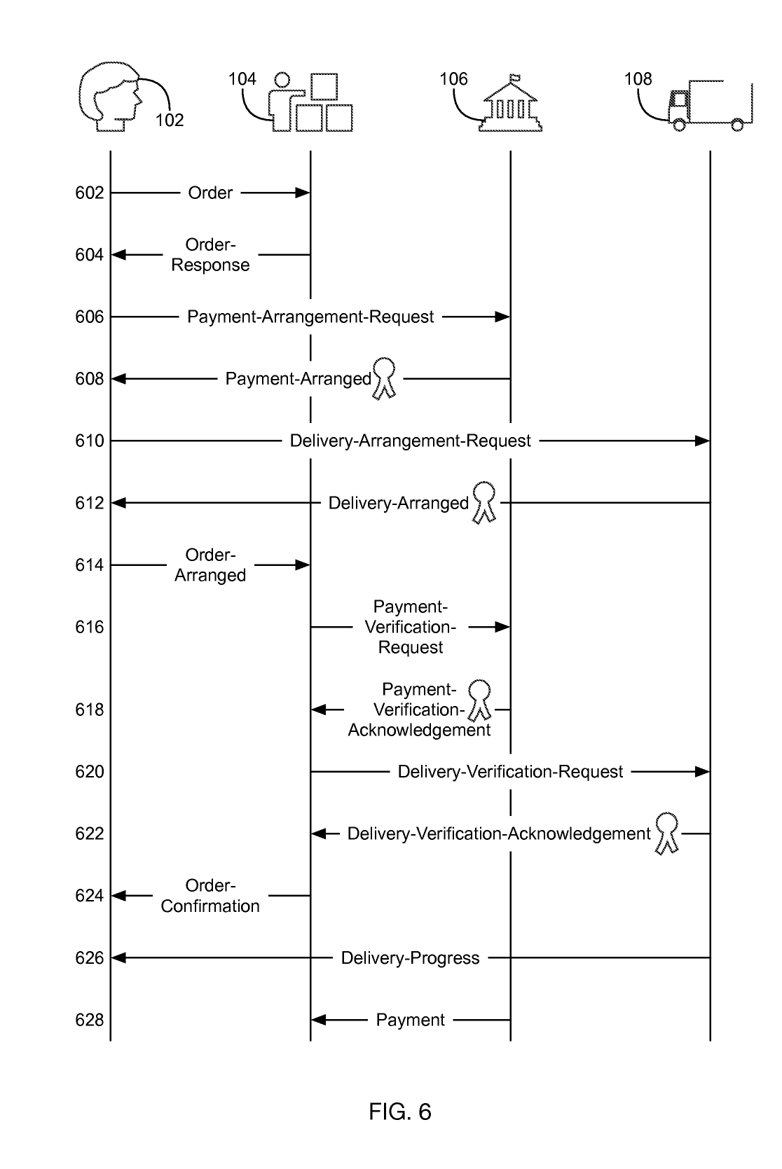

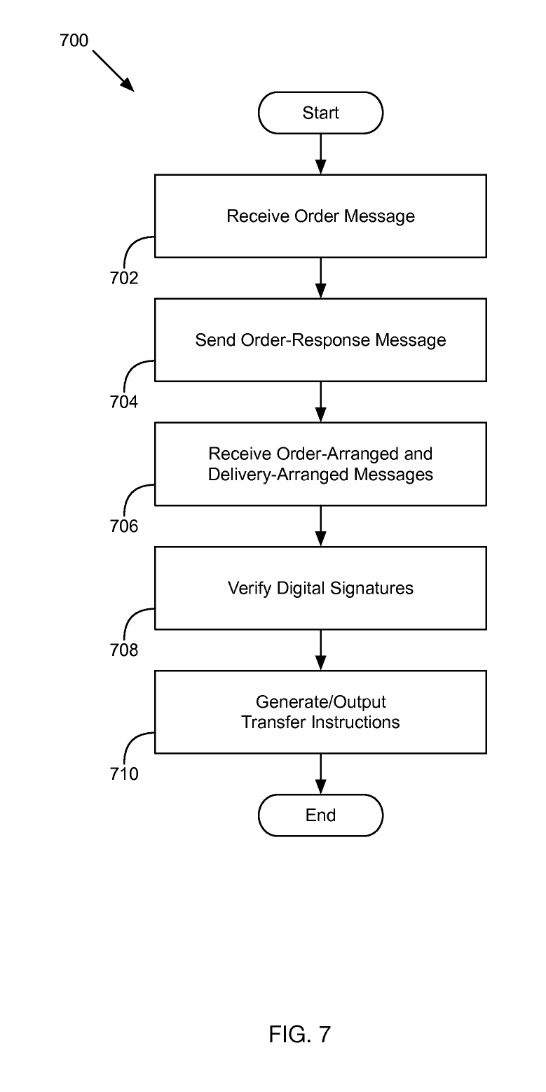

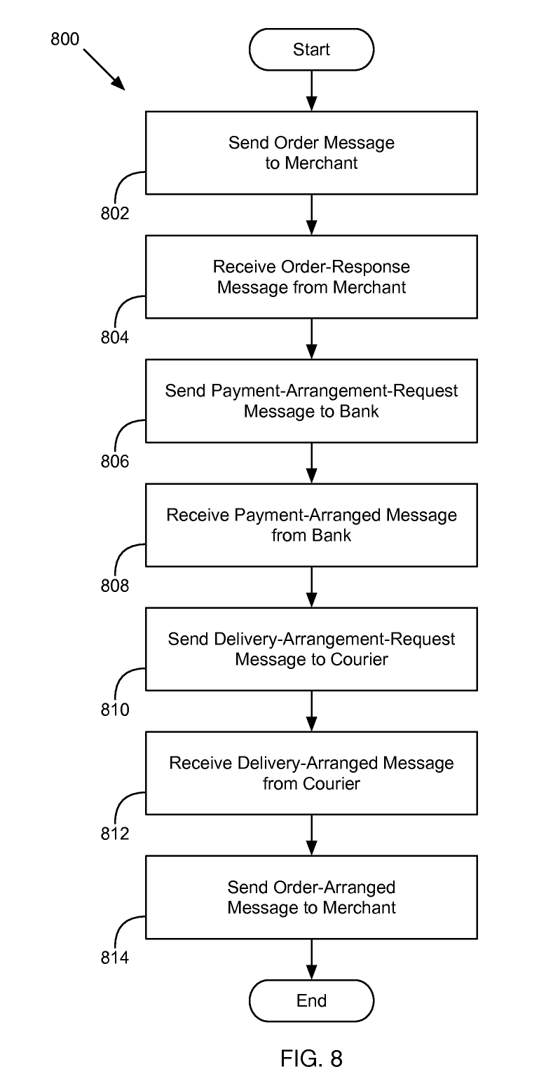

FIG. 6 depicts a second message flow, in accordance with at least one embodiment. As shown, one or more messages 602-628 are exchanged between client device 102, merchant server 104, financial-institution server 106, and courier server 108. It should be understood that different and/or additional messages may be exchanged between computing devices 102-108, and that different and/or additional computing devices may send and/or receive any one or more of messages 602-628. Various aspects of messages 602-628, as well as other possible messages, are described throughout this disclosure, including below with reference to FIGS. 7 and 8.

In some embodiments, one or more of the messages (such as payment-arranged message 608 and/or delivery-arranged message 612, among others) include respective digital signatures, which is depicted in FIG. 6 as messages with an accompanying ribbon icon. It should be understood that one or message messages that are depicted without a ribbon icon could also include respective digital signatures, and that any of the messages depicted with a ribbon icon need not necessarily include a digital signature.

### Example Merchant-Server Method

FIG. 7 depicts a flowchart of a method carried out by merchant server 104, in accordance with at least one embodiment. As shown, method 700 begins at step 702 with merchant server 104 receiving, from client device 102, an order message 602 that identifies an ordered product. The ordered product has a purchase price, though that price needn't be identified in order message 602. The order message may identify the product based (at least in part) on a Universal Product Code (UPC), International Article Number (IAN), an International Standard Book Number (ISBN), a merchant-specific identifier, and/or any identifier that uniquely identifies one or more products, among other examples.

Different and/or additional data may be included in order message 602. For example, order message 602 may include an ordered quantity of the ordered product, a shipping-destination location, one or more preferred couriers, a preferred delivery method (e.g., expedited delivery or normal delivery), a preferred payment method, and/or data relating to Value-Added Tax (VAT), among numerous other examples. Some information, such as a shipping-destination location, could be indicated with sufficient specificity to allow the merchant to process the order (e.g., to calculate a shipping price for the order), but not so specific that the merchant could obtain personally-identifying information (e.g., a shipping-destination street address).

It will be apparent to those of skill in the art that order message 602 may identify multiple ordered products and that information included in order message 602 may apply to some or all of the ordered products. For example, order message 602 could indicate a single preferred delivery method for all of the ordered products identified in order message 602, and/or could indicate respective delivery methods for each of the ordered products, among other possible variations.

At step 704, merchant server 104 generates an order identifier associated with the ordered product. The order identifier may uniquely identify the order with respect to, for example, other orders from the given merchant and/or from several merchants. For example, the order identifier could include a concatenation of (i) an identifier that uniquely identifies the order with respect to the given merchant and (i) an identifier of the given merchant. Merchant server 104 may store, perhaps in data storage 204 or another data storage, some or all of the information included in order message 602 in association with the generated order identifier. The order identifier can be used by client device 102, financial-institution server 106, courier server 108, and/or other entities to identify the order without revealing personally-identifying information of the client.

Merchant server 104 sends, to client device 102, an order-response message 604 that includes the generated order identifier. Additionally, order-response message 604 may include an identification and/or description of the ordered product, the purchase price of the ordered product, a merchant identifier that uniquely identifies the merchant associated with merchant server 104 (if, e.g., the order identifier does not identify the merchant), bank and/or payment information of the merchant, and/or information regarding one or more of the couriers identified in order message 602, among numerous other examples.

In at least one embodiment, prior to sending order-response message 604 to client device 102, merchant server 104 inserts, into order-response message 604, a digital signature associated with merchant server 104. The inserted digital signature may allow client device 102 (or any other recipient of order-message 604) to verify the authenticity and integrity of order-response message 604. Order-response message 604 (and/or any other message that includes a digital signature) could take the form of (or include) an S/MIME message. Additional aspects of digital signatures are described throughout this disclosure (including below with reference to FIG. 8).

In at least one embodiment, order-response message 604 includes client instructions that, if executed by client device 102, cause client device 102 to perform the method described below with reference to FIG. 8. For example, the client instructions could cause client device 102 to, prior to sending an order-arranged message 614 to merchant server 104, verify any digital signatures of the financial institution and/or courier that may be included in any payment-arranged messages 608 and/or delivery-arranged messages 612 received by the client device. The client instructions to send (to financial-institution server 106) a payment-arrangement-request message 606 could include instructions to include a digital signature of client device 102 in the payment-arrangement-request message. In at least one embodiment, the client instructions to send (to courier server 108) a delivery-arrangement-request message 610 include instructions to include a digital signature of client device 102 in the delivery-arrangement-request message. Various aspects of these messages are described in additional detail throughout this disclosure (including below with reference to FIG. 8).

At step 706, merchant server 104 receives, from client device 102, order-arranged message 614 that includes payment-arranged message 608 and delivery-arranged message 612. Payment-arranged message 608 includes a payment amount, the order identifier, and a digital signature of a financial institution. Delivery-arranged message 612 includes delivery-plan data and a digital signature of a courier. In some embodiments, payment-arranged message 608 contains different and/or additional data such as a financial-institution identifier that uniquely identifies the financial institution that signed payment-arranged message 608, additional information regarding the financial institution, a merchant identifier and/or other information regarding the merchant, and/or a payment identifier that uniquely identifies the payment arrangement that is memorialized by payment-arranged message 608, among numerous other possibilities. The delivery-plan data of delivery-arranged message 612 may indicate, for example, a time and/or place that the signing courier will pick up (or where the merchant may drop off) packages containing the ordered products, etc. Delivery-arranged message 612 may contain different and/or additional data such as a courier identifier that uniquely identifies the courier that signed delivery-arranged message 612, additional information regarding the courier, a merchant identifier and/or other information regarding the merchant, and/or a delivery identifier that uniquely identifies the delivery arrangement that is memorialized by delivery-arranged message 612, among other examples.

At step 708, merchant server 104 verifies the digital signature of the financial institution and verifies the digital signature of the courier. As described above, the respective digital signatures allow merchant server 104 to verify that payment-arranged message 608 and delivery-arranged message 612 were not altered by client device 102. The digital signatures also prevent the financial institution and the courier from being able to deny having signed the respective messages. Payment-arranged message 608 may therefore function as a commitment or intention, by the financial institution, to provide the merchant with payment (in the amount specified in payment-arranged message 608) towards the purchase of the product associated with the order identifier specified in payment-arranged message 608. Likewise, delivery-arranged message 612 may function as, for example, confirmation that the courier will (or intends to) provide the courier services indicated in the delivery-plan data.

In at least one embodiment, the digital signature of the financial institution is based on a private key that is inaccessible to merchant server 104. Generally, this private key will be secret to all parties except for the financial institution. Verifying the digital signature of the financial institution may include verifying the digital signature based on a public key that is associated with the private key and that is accessible to merchant server 104. The financial institution may have distributed the public key to any parties that intend to authenticate any messages that purportedly originated from the financial institution. Merchant server 104 may access the public key from a digital certificate that further includes identity information of the financial institution and a digital signature of a trusted certificate authority. Common examples of trusted certificate authorities include Symantec®, VeriSign®, Thawte®, Geotrust®, Comodo®, Go Daddy®, and GlobalSign®, among numerous others. The digital signature indicates that the certificate authority has verified that the entity identified in the certificate (in this case, the financial institution) is the possessor of a private key associated with the included public key.

Similarly, in at least one embodiment, the digital signature of the courier is based on a private key that is inaccessible to merchant server 104. Verifying the digital signature of the courier may include verifying the digital signature based on a public key that is associated with the private key and that is accessible to merchant server 104. Merchant server 104 may access the public key from a digital certificate that further includes identity information of the courier and a digital signature of a trusted certificate authority.

In at least one embodiment, the merchant server generates an order-confirmation message 624 that includes the received payment-arranged message and the received delivery-arranged message. The merchant server inserts, into the order-confirmation message 624, a digital signature associated with the merchant server, and sends the order-confirmation message 624 to the client device. The signed order-confirmation message 624 may function as a receipt for the order (if, for example, the client desires to return any ordered products to the merchant).

At step 710, merchant server 104 generates transfer instructions for the ordered product based at least in part on the delivery-plan data. The transfer instructions could include, for example, instructions (e.g., to a warehouse worker) for locating the storage location of the ordered product in the merchant's warehouse, instructions (perhaps to a warehouse worker) for transferring possession of the ordered product from the merchant to the courier (for delivery by the courier), and/or instructions to the courier for obtaining the ordered product from the merchant, as examples. Merchant server 104 then outputs the generated transfer instructions, e.g., by printing the instructions via a printer located in a warehouse and/or by sending an email or other electronic notification to a warehouse worker or courier, among other possibilities. In some embodiments, the transfer instructions include a shipping label that can be applied to packaging containing the ordered product.

Prior to outputting the transfer instructions, merchant server 104 may verify that the order identifier received in payment-arranged message 608 matches the generated order identifier. As another possibility, the merchant server may receive (from the financial institution and in association with the order identifier) payment 628 in the amount of the payment amount, and/or may verify that the payment amount matches the purchase price. Further, the merchant server 104 may verify that an order identifier included in delivery-arranged message 612 matches the generated order identifier. The merchant server may perform any combination of these and/or other verifications prior to outputting the transfer instructions.

Given that payment-arranged message 608 and delivery-arranged message 612 were received from client device 102 (and were not received directly from financial-institution server 106 and courier server 108, respectively), the merchant may desire to verify the authenticity of these messages by communicating directly with the signing parties. For example, the merchant may desire to verify these messages if, for example, the messages did not include any digital signatures or if the merchant does not trust the certificate authority that signed a certificate purportedly verifying the identity of the financial institution and/or courier.

Accordingly, in an embodiment, prior to outputting the transfer instructions, merchant server 104 sends, to financial-institution server 106 associated with the financial institution, payment-verification-request message 616 that includes the order identifier and the purchase price. Subsequently, merchant server 104 receives, from financial-institution server 106, payment-verification-acknowledgement message 618 that includes the order identifier, a payment-verification indicator, a verified-payment amount, and a digital signature of the financial institution. Merchant server 104 may then verify the digital signature included in the payment-verification-acknowledgement message, confirm that the payment-verification indicator is true, and confirm that the verified-payment amount is equal to the purchase price.

Similarly, in an embodiment, prior to outputting the transfer instructions, merchant server 104 sends, to courier server 108 associated with the courier, delivery-verification-request message 620 that includes the order identifier. Merchant server 104 subsequently receives, from courier server 108, delivery-verification-acknowledgement message 622 that includes the order identifier, a delivery-verification indicator, and a digital signature of the courier. Merchant server could then verify the digital signature included in the delivery-verification-acknowledgement message 622, and confirm that the delivery-verification indicator is true.

In some embodiments, several seconds, minutes, hours, or even days may pass between the time that merchant server 104 sends order-response message 604 to client device 102 and the time that the merchant server receives order-arranged message 614 from the client device. In that intervening time, changes to the merchant's inventory, the merchant's relationship with the financial institution and/or courier, the price of the ordered product, etc., may result in the merchant server being unable to complete the sale of the ordered product.

If merchant server 104 makes a determination that the sale of the ordered product cannot be completed, the merchant server may send an order-exception message to the client device. The order-exception may include metadata indicating that, for example, the ordered product is out of stock, the bank is no longer able to pay the merchant (e.g., because the purchaser's bank account contains insufficient funds), and/or the selected courier cannot deliver the ordered product, among other possibilities.

Merchant server 104 may send an order-exception message to client device 102 in response to making a determination that the sale of the ordered product cannot be completed. The order-exception may include metadata indicating that, for example, the ordered product is out of stock, the bank is no longer able to pay the merchant (e.g., because the purchaser's bank account contains insufficient funds), the selected courier cannot deliver the ordered product, the merchant server is unable to verify a digital signature, the format of a given message is incorrect, and/or the merchant server was unable to communicate with financial-institution server 106 and/or courier server 108 (e.g., because of a connection timeout), among other possibilities. Merchant server 104 may forward to client device 102 any order-exception messages received from financial-institution server 106 because of insufficient funds and/or order-exception messages received from courier server 108 as a result of the courier being unable to deliver the ordered product to the requested delivery location, as examples.

### Example Client-Device Method

FIG. 8 depicts a flowchart of a method carried out by client device 102, in accordance with at least one embodiment. As shown, method 800 begins at step 802 with client device 102 sending order message 602 to merchant server 104 and, at step 804, receiving order-response message 604 from merchant server 104.

At step 806, client device 102 sends, to financial-institution server 106 associated with the financial institution, payment-arrangement-request message 606 that includes the order identifier and the purchase price. Prior to sending the message, client device 102 may insert into the message a digital signature associated with the client device. Subsequently, at step 808, client device 102 receives, from financial-institution server 106, payment-arranged message 608 that includes a payment amount, the order identifier, and a digital signature of the financial institution.

Similarly, at step 810, client device 102 sends, to courier server 108 associated with the courier, delivery-arrangement-request message 610 that includes the order identifier. The delivery-arrangement request could also include the weight and/or dimensions of the ordered product, among other examples discussed herein. Prior to sending the message, client device 102 may insert into the message a digital signature associated with the client device. Subsequently, at step 812, client device 102 receives, from courier server 108, delivery-arranged message 612 that includes delivery-plan data and a digital signature of a courier.

At step 814, client device 102 generates order-arranged message 614 that includes payment-arranged message 608 and delivery-arranged message 612, and sends the generated order-arranged message 614 to merchant server 104. In at least one embodiment, prior to sending generated order-arranged message 614 to merchant server 104, client device 102 verifies the digital signature of the financial institution and/or verifies the digital signature of the courier.

It should be noted that, while client device 102 may digitally sign messages sent by the client device to financial-institution server 106 and/or courier server 108, the client device likely would not sign any messages sent to merchant server 104. Given that digital signatures can often be used to verify that a given entity signed the messages, any digitally-signed messages received by merchant server 104 could possibly be used to obtain personally-identifying information of the client. At the least, the client device likely would not sign the messages using the same private key used to sign messages from a previous purchase. To encrypt and/or authenticate a given communication session with merchant server 104, client device 102 may generate an ephemeral key for use during the communication session. And certainly other possible implementations could be listed here.

### Example Wireless Transmit/Receive Unit

Methods described herein may be performed by modules that carry out (i.e., perform, execute, and the like) various functions that are described herein. As used in this disclosure, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

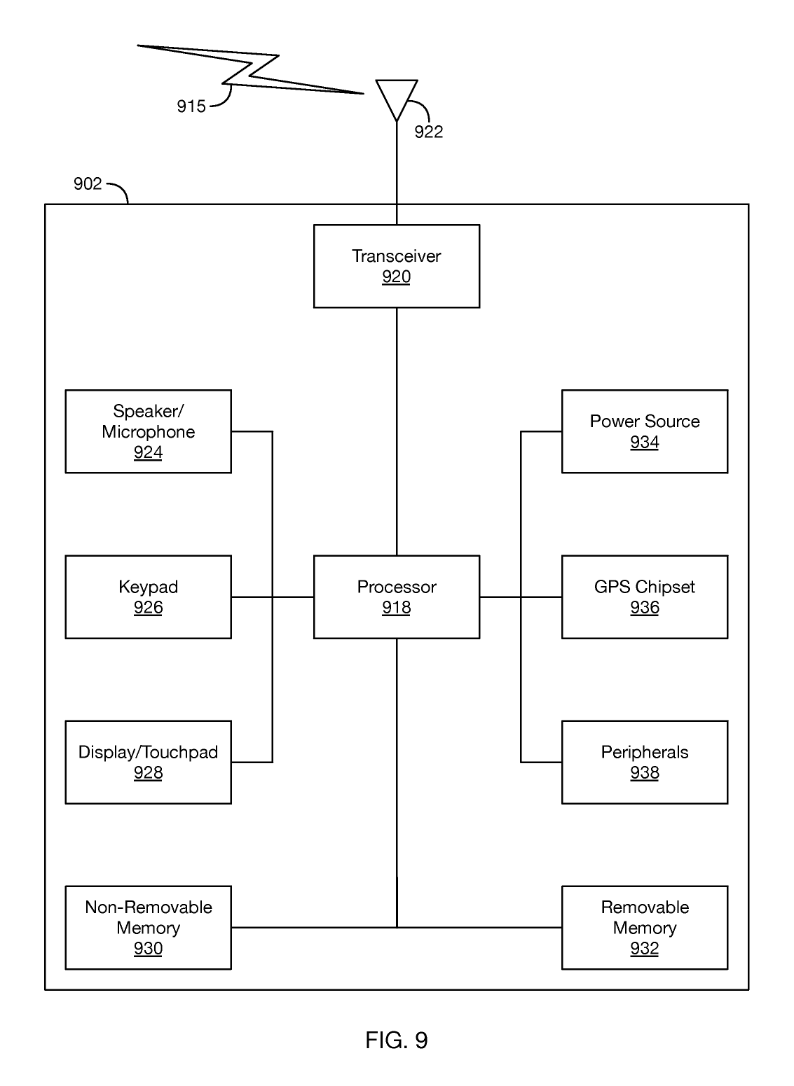

In some embodiments, the systems and methods described herein may be implemented in a wireless transmit receive unit (WTRU), such as WTRU 902 illustrated in FIG. 9. In some embodiments, the components of WTRU 902 may be implemented in a user agent, a created service, a device incorporating a user agent and/or created service, or any combination of these, as examples. As shown in FIG. 9, the WTRU 902 may include a processor 918, a transceiver 920, a transmit/receive element 922, audio transducers 924 (preferably including at least two microphones and at least two speakers, which may be earphones), a keypad 926, a display/touchpad 928, a non-removable memory 930, a removable memory 932, a power source 934, a global positioning system (GPS) chipset 936, and other peripherals 938. It will be appreciated that the WTRU 902 may include any sub-combination of the foregoing elements while remaining consistent with an embodiment. The WTRU may communication to nodes such as, but not limited to, base transceiver station (BTS), a Node-B, a site controller, an access point (AP), a home node-B, an evolved home node-B (eNodeB), a home evolved node-B (HeNB), a home evolved node-B gateway, and proxy nodes, among others.

The processor 918 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 918 may perform signal coding, data processing, power control, input/output processing, and/or any other functionality that enables the WTRU 902 to operate in a wireless environment. The processor 918 may be coupled to the transceiver 920, which may be coupled to the transmit/receive element 922. While FIG. 9 depicts the processor 918 and the transceiver 920 as separate components, it will be appreciated that the processor 918 and the transceiver 920 may be integrated together in an electronic package or chip.

The transmit/receive element 922 may be configured to transmit signals to, or receive signals from, a node over the air interface 915. For example, in one embodiment, the transmit/receive element 922 may be an antenna configured to transmit and/or receive RF signals. In another embodiment, the transmit/receive element 922 may be an emitter/detector configured to transmit and/or receive IR, UV, or visible light signals, as examples. In yet another embodiment, the transmit/receive element 922 may be configured to transmit and receive both RF and light signals. It will be appreciated that the transmit/receive element 922 may be configured to transmit and/or receive any combination of wireless signals.

In addition, although the transmit/receive element 922 is depicted in FIG. 9 as a single element, the WTRU 902 may include any number of transmit/receive elements 922. More specifically, the WTRU 902 may employ MIMO technology. Thus, in one embodiment, the WTRU 902 may include two or more transmit/receive elements 922 (e.g., multiple antennas) for transmitting and receiving wireless signals over the air interface 915.

The transceiver 920 may be configured to modulate the signals that are to be transmitted by the transmit/receive element 922 and to demodulate the signals that are received by the transmit/receive element 922. As noted above, the WTRU 902 may have multi-mode capabilities. Thus, the transceiver 920 may include multiple transceivers for enabling the WTRU 902 to communicate via multiple RATs, such as UTRA and IEEE 802.11, as examples.

The processor 918 of the WTRU 902 may be coupled to, and may receive user input data from, the audio transducers 924, the keypad 926, and/or the display/touchpad 928 (e.g., a liquid crystal display (LCD) display unit or organic light-emitting diode (OLED) display unit). The processor 918 may also output user data to the speaker/microphone 924, the keypad 926, and/or the display/touchpad 928. In addition, the processor 918 may access information from, and store data in, any type of suitable memory, such as the non-removable memory 930 and/or the removable memory 932. The non-removable memory 930 may include random-access memory (RAM), read-only memory (ROM), a hard disk, or any other type of memory storage device. The removable memory 932 may include a subscriber identity module (SIM) card, a memory stick, a secure digital (SD) memory card, and the like. In other embodiments, the processor 918 may access information from, and store data in, memory that is not physically located on the WTRU 902, such as on a server or a home computer (not shown).

The processor 918 may receive power from the power source 934, and may be configured to distribute and/or control the power to the other components in the WTRU 902. The power source 934 may be any suitable device for powering the WTRU 902. As examples, the power source 934 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 918 may also be coupled to the GPS chipset 936, which may be configured to provide location information (e.g., longitude and latitude) regarding the current location of the WTRU 902. In addition to, or in lieu of, the information from the GPS chipset 936, the WTRU 902 may receive location information over the air interface 915 from a base station and/or determine its location based on the timing of the signals being received from two or more nearby base stations. It will be appreciated that the WTRU 902 may acquire location information by way of any suitable location-determination method while remaining consistent with an embodiment.

The processor 918 may further be coupled to other peripherals 938, which may include one or more software and/or hardware modules that provide additional features, functionality and/or wired or wireless connectivity, including sensor functionality. For example, the peripherals 938 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method carried out by a merchant server, the method comprising:
receiving, from a client device, an order message identifying an ordered product, the ordered product having a purchase price;
generating an order identifier associated with the ordered product, and sending, to the client device, an order-response message that includes the generated order identifier;
receiving, from the client device, an order-arranged message that includes a payment-arranged message and a delivery-arranged message, the payment-arranged message including a payment amount, the order identifier, and a digital signature of a financial institution, the delivery-arranged message including delivery-plan data and a digital signature of a courier;
verifying the respective digital signatures of the financial institution and the courier; and
in response to the verification, generating transfer instructions for the ordered product based at least in part on the delivery-plan data, and outputting the generated transfer instructions.

2. The method of claim 1, further comprising, in response to the transfer instructions, releasing the ordered product to the courier.

3. The method of claim 1, further comprising:
prior to sending the order-response message to the client device:
inserting into the order-response message a digital signature associated with the merchant server.

4. The method of claim 1, wherein:
the digital signature of the financial institution was generated based on a private key that is inaccessible to the merchant server; and
verifying the digital signature of the financial institution comprises verifying the digital signature of the financial institution based on a public key that is associated with the private key and that is accessible to the merchant server.

5. The method of claim 1, wherein:
the transfer instructions comprise instructions for transferring possession of the ordered product (i) from a merchant associated with the merchant server and (ii) to the courier.

6. The method of claim 1, further comprising:
prior to outputting the generated transfer instructions:
verifying that the order identifier received in the payment-arranged message matches the generated order identifier; and
verifying that the payment amount matches the purchase price.

7. The method of claim 1, further comprising:
prior to outputting the generated transfer instructions:
sending, to a financial-institution server associated with the financial institution, a payment-verification-request message that includes the order identifier and the purchase price;
receiving, from the financial-institution server, a payment-verification-acknowledgement message that includes the order identifier, a payment-verification indicator, a verified-payment amount, and a second digital signature of the financial institution;
verifying the second digital signature of the financial institution;
confirming that the payment-verification indicator is true; and
confirming that the verified-payment amount is equal to the purchase price.

8. The method of claim 1, wherein:
the digital signature of the courier was generated based on a private key that is inaccessible to the merchant server; and
verifying the digital signature of the courier comprises verifying the digital signature of the courier based on a public key that is associated with the private key and that is accessible to the merchant server.

9. The method of claim 1, wherein:
the delivery-plan data includes the order identifier; and
the method further comprises verifying that the order identifier received in the delivery-plan data matches the generated order identifier.

10. The method of claim 1, further comprising:
prior to outputting the generated transfer instructions:
sending, to a courier server associated with the courier, a delivery-verification-request message that includes the order identifier;
receiving, from the courier server, a delivery-verification-acknowledgement message that includes the order identifier, a delivery-verification indicator, and a second digital signature of the courier;
verifying the second digital signature of the courier; and
confirming that the delivery-verification indicator is true.

11. The method of claim 1, wherein:
the order-response message comprises client instructions that, if executed by the client device, cause the client device to:
send, to a financial-institution server associated with the financial institution, a payment-arrangement-request message that includes the order identifier and the purchase price;
receive the payment-arranged message from the financial-institution server;
send, to a courier server associated with the courier, a delivery-arrangement-request message that includes the order identifier;
receive the delivery-arranged message from the courier server; and
generate the order-arranged message to include the payment-arranged message and the delivery-arranged message, and send the generated order-arranged message to the merchant server.

12. The method of claim 11, wherein:
the client instructions further cause the client device to, prior to sending the order-arranged message to the merchant server:
verify the respective digital signatures of the financial institution and the courier.

13. The method of claim 11, wherein:
the client instructions to send the payment-arrangement-request message comprise instructions to include a digital signature of the client device in the payment-arrangement-request message.

14. The method of claim 11, wherein:
the client instructions to send the delivery-arrangement-request message comprise instructions to include a digital signature of the client device in the delivery-arrangement-request message.

15. The method of claim 1, further comprising:
generating an order-confirmation message that includes the received payment-arranged message and the received delivery-arranged message;
inserting into the order-confirmation message a digital signature associated with the merchant server; and
sending the order-confirmation message to the client device.

16. A merchant server comprising:
a communication interface;
a processor; and
data storage containing instructions executable by the processor for causing the server to carry out a set of functions, the set of functions including:
receiving, from a client device, an order message identifying an ordered product, the ordered product having a purchase price;
generating an order identifier associated with the ordered product, and sending, to the client device, an order-response message that includes the generated order identifier;
receiving, from the client device, an order-arranged message that includes a payment-arranged message and a delivery-arranged message, the payment-arranged message including a payment amount, the order identifier, and a digital signature of a financial institution, the delivery-arranged message including delivery-plan data and a digital signature of a courier;
verifying the respective digital signatures of the financial institution and the courier; and
in response to the verification, generating transfer instructions for the ordered product based at least in part on the delivery-plan data, and outputting the generated transfer instructions.

17. A method carried out by a client device, the method comprising:
sending, to a merchant server, an order message identifying an ordered product, the ordered product having a purchase price;
receiving, from the merchant server, an order-response message that includes an order identifier associated with the ordered product;
sending, to a financial-institution server associated with a financial institution, a payment-arrangement-request message that includes the order identifier and the purchase price;
receiving, from the financial-institution server, a payment-arranged message that includes a payment amount, the order identifier, and a digital signature of the financial institution;
sending, to a courier server associated with a courier, a delivery-arrangement-request message that includes the order identifier;
receiving, from the courier server, a delivery-arranged message that includes delivery-plan data and a digital signature of a courier; and
generating an order-arranged message that includes the payment-arranged message and the delivery-arranged message, and sending the generated order-arranged message to the merchant server.

18. The method of claim 17, further comprising:
prior to sending the generated order-arranged message to the merchant server:
verifying the respective digital signatures of the financial institution and the courier.

19. The method of claim 17, further comprising:
prior to sending the payment-arrangement-request message to the financial-institution server:
inserting into the payment-arrangement-request message a digital signature associated with the client device.

20. The method of claim 17, further comprising:
prior to sending the delivery-arrangement-request message to the courier server:
inserting into the delivery-arrangement-request message a digital signature associated with the client device.
